(19) United States
(12) Patent Application Publication
(10) Pub. No.: US 2006/0188186 A1
(43) Pub. Date: Aug. 24, 2006

(54) Fluid dynamic pressure bearing device, spindle motor provided with the fluid dynamic pressure bearing device, and recording disk drive device with the fluid dynamic pressure bearing device

(75) Inventor: Tadashi Akahori, Kitasaku-Gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-Gun (JP)

(21) Appl. No.: 11/342,640

(22) Filed: Jan. 31, 2006

(30) Foreign Application Priority Data
Feb. 3, 2005 (JP) 2005-000463 U

(51) Int. Cl. F16C 32/06

(52) U.S. Cl. 384/107

(57) ABSTRACT

In a fluid dynamic pressure bearing device, a shaft member includes a shaft member-side annular member, and end surfaces of the shaft member and/or the shaft member-side annular member contact a base member of a motor. The shaft member is fixed to the base member. A bearing member is rotatably engaged with the shaft member, and a rotor hub of the motor is engaged with the bearing member. A bearing member-side annular member engaged with the rotor hub suppresses the bearing member from being pulled out in the direction of the base member. A capillary seal portion is formed by a micro gap between the shaft member-side annular member and the bearing member-side annular member. The capillary seal portion suppresses leakage of lubricant occupying the micro gap.

### BACKGROUND

This invention relates to a fluid dynamic pressure bearing device that can obtain high bearing rigidity by generating a dynamic pressure in lubricant, a spindle motor provided with the fluid dynamic pressure bearing device, and a recording disk drive device provided with the spindle motor. In particular, this invention relates to a thin fluid dynamic pressure bearing device in which a shaft member is fixed to a base member and a bearing member is rotatably supported on the shaft member via a micro gap.

In general, a fluid dynamic pressure bearing device that is preferably used for a spindle motor or the like has a structure in which a lower end of a shaft member is press-fitted into a hole portion that extends into a boss portion of a base member of the motor. A bearing member is rotatably supported on the shaft member. A radial dynamic pressure bearing portion is formed between the shaft member and the bearing member by a radial dynamic pressure groove formed on either an outer circumferential surface of the shaft member or an inner circumferential surface of the bearing member. Meanwhile, thrust dynamic pressure grooves are formed on both upper and lower end surfaces of a thrust plate arranged at an upper end portion of the shaft member, and thrust dynamic pressure bearing portions are formed between the upper and lower end surfaces of the thrust plate and surfaces of the bearing member that respectively face the upper and lower end surfaces of the thrust plate.

Recently, in spindle motors and recording disk drive devices such as hard disk drive devices that house spindle motors, there is a strong demand for miniaturization and thinness. In order to meet this demand, it is effective to reduce the axial direction length of the shaft member in a fluid dynamic pressure bearing device. However, by so doing, the axial direction length of the radial dynamic pressure bearing portion is reduced, and bearing rigidity deteriorates. Furthermore, a sufficient press-in amount for fixing the shaft member to the base member cannot be obtained, and mounting rigidity of the shaft member is reduced.

Therefore, in order to solve this problem, a fluid dynamic pressure bearing device has been proposed in which a disk-shaped thrust plate is arranged on the shaft member, a rotor hub is engaged with this thrust plate via a micro gap, and a radial dynamic pressure bearing portion is constituted between an outer circumferential portion of the thrust plate and an inner circumferential portion of the rotor hub. A thrust dynamic pressure bearing portion is constituted between both upper and lower end surfaces of the thrust plate and the respective end surfaces of a pair of disk-shaped thrust bushings mounted so as to respectively face the two end surfaces. An example of this structure is shown in Japanese Laid-Open Patent Application 8-84453 (JP-A-8-84453) (see Abstract, FIGS. 1 and 2, etc.). According to this fluid dynamic pressure bearing device, even if the length of the shaft member is reduced, the necessary axial direction length for the radial dynamic pressure bearing portion and the press-in amount for fixing the shaft member to the base member can be obtained.

Incidentally, in a spindle motor provided with a fluid dynamic pressure bearing device, it is known that when a diameter of the radial dynamic pressure bearing portion increases, the shaft torque becomes large, and electricity consumption of the spindle motor increases. Therefore, if the radial dynamic pressure bearing portion is set at an outer circumferential portion of a disk-shaped thrust plate, as in the bearing device described in the above-mentioned reference, instead of being set at an outer circumferential portion of the shaft member, the diameter of the radial dynamic pressure bearing portion naturally becomes large. Therefore, electricity consumption increases, and the bearing device is not preferable for a thin, small spindle motor and recording disk drive device with minimum electricity consumption.

### SUMMARY

Exemplary embodiments of this invention may provide a fluid dynamic pressure bearing device in which: (1) the diameter of a radial dynamic pressure bearing portion in the fluid dynamic pressure bearing device is not increased; (2) mounting rigidity of a shaft member is not reduced; (3) the necessary axial direction length of the radial dynamic pressure bearing portion is maintained; and (4) the necessary bearing rigidity is obtained. By accomplishing at least some of these objectives, thinness and miniaturization can be improved. The invention may also provide a spindle motor provided with this fluid dynamic pressure bearing device and a recording disk drive device provided with this fluid dynamic pressure bearing device.

Exemplary embodiments of the invention provide a fluid dynamic pressure bearing device including: a shaft member including a first end that attaches to a base member of a motor; a bearing member that engages a rotor hub of the motor, a micro gap being formed between the shaft member and the bearing member; a shaft member-side annular member; and a bearing member-side annular member. The shaft member-side annular member engages with the shaft member, and includes a first end surface that contacts the base member of the motor. An outer circumferential surface of the shaft member-side annular member includes a step and/or a taper that reduces in diameter progressing toward the first end surface. The bearing member-side annular member engages with the bearing member and/or with the rotor hub of the motor. An inner circumferential surface of the bearing member-side annular member includes a step and/or a taper that reduces in diameter progressing toward the base member of the motor. The outer circumferential surface of the shaft member-side annular member and the inner circumferential surface of the bearing member-side annular member face each other and are adjacent to each other in an axial direction and in a radial direction. A capillary seal portion that suppresses lubricant occupying the micro gap from leaking is formed between the shaft member-side annular member and the bearing member-side annular member. At least one first dynamic pressure groove is formed in either an outer circumferential surface of the shaft member or an inner circumferential surface of the bearing member, and generates a radial dynamic pressure that receives a load in a radial direction. At least one second dynamic pressure groove is formed in either a second end surface of the shaft member-side annular member facing the bearing member or an end surface of the bearing member facing the second end surface of the shaft member-side annular member. The at least one second dynamic pressure groove generates a thrust dynamic pressure that receives a load in a thrust direction.

Thus, in this structure, a step and/or a taper that reduces in diameter progressing toward the base member (toward one end in the axial direction) is arranged on an outer circumferential surface of the shaft member-side annular member and an inner circumferential surface of the bearing member-side annular member. The outer circumferential surface of the shaft member-side annular member and the inner circumferential surface of the bearing member-side annular member are adjacent to each other in the axial direction and the radial direction, and are arranged facing each other. According to this state, as the inner circumferential portion of the bearing member-side annular member and the outer circumferential portion of the shaft member-side annular member are engaged with each other, the bearing member and the shaft member of the rotor hub are suppressed from being pulled out in the direction opposite to the base member (toward the other end in the axial direction). Additionally, the tapers and/or steps which are arranged on the outer circumferential surface of the shaft member-side annular member and the inner circumferential surface of the bearing member-side annular member face each other, so a capillary seal portion is formed for suppressing lubricant from leaking to the outside. Furthermore, the bearing member and the rotor hub are suppressed from being pulled out in the direction of the base member by the axial direction end surface of the bearing member being arranged to contact or be adjacent to the shaft member-side annular member. Thus, instead of a conventional structure in which pull-out suppression of the bearing member and the rotor hub and sealing of lubricant are performed by a flange portion, a step portion, or the like separately formed on the shaft member, a structure is used in which a shaft member-side annular member, on which a thrust dynamic pressure groove or a thrust dynamic pressure generating surface is formed, and a bearing member-side annular member are engaged with each other. Therefore, the axial direction length is not used for extra members or the like, and the axial direction length of the radial dynamic pressure bearing portion of the shaft member is not reduced. In other words, the radial dynamic pressure bearing portion of the shaft member can be maximized, whereby bearing rigidity can be improved.

Furthermore, according to exemplary embodiments of the fluid dynamic pressure bearing device of this invention, the shaft member-side annular member, of which the diameter is larger than that of the shaft member, is fixed to the base member along with the shaft member in a state in which an axial end surface of the shaft member-side annular member contacts the base member. Thus, the shaft member can be stably fixed to the base member with high accuracy. As a result, mounting rigidity of a shaft can be assured. Furthermore, even if the shaft member is shortened, it is thus stably fixed to the base member with high accuracy. Therefore, a desired right angle of the shaft member with respect to the base member and a desired parallelism of the shaft member-side annular member with respect to the base member can be obtained with high accuracy. Furthermore, in turn, a micro gap including a thrust dynamic pressure generating portion and a radial dynamic pressure generating portion is formed with high accuracy between the shaft member and the bearing member, and a desired dynamic pressure can be obtained. As a result, bearing rigidity can be improved. Therefore, when this feature is applied to a bearing device of a spindle motor, miniaturization and thinness of the spindle motor or a recording disk drive device are improved.

According to preferred embodiments, a fluid dynamic pressure bearing device of this invention can obtain a shaft member-side annular member with high rigidity by forming the shaft member-side annular member, which contacts a base member, of tempered steel. Thus, stability of the shaft member fixed to the base member increases. Furthermore, in this state, if the surface of the shaft member-side annular member that contacts the base member (one end surface in the axial direction) is polished after heat processing, mounting accuracy of the shaft member with respect to the base member can be further improved. Additionally, if the other axial direction end surface of the shaft member-side annular member, which faces an axial direction end surface of the bearing member, is polished after heat processing, rotation accuracy can be improved by generating a thrust dynamic pressure without any deviation with respect to the rotation axis.

It is also acceptable to integrally form the shaft member-side annular member together with the shaft member. If a shaft member with a flange is used in which the shaft member-side annular member and the shaft member are integrally formed, an assembly operation can be omitted in which the shaft member-side annular member is engaged with the shaft member, and generation of assembly errors can be suppressed. As a result, accuracy of the bearing device itself is improved. Furthermore, the number of parts is reduced, whereby the cost can be reduced.

An end portion of the bearing member opposite to the base member may have an opening, and this opening may be sealed by a lid member. According to this embodiment, the bearing member can be constituted by a tubular member, which is a simple structure that is easy to manufacture.

A spindle motor according to this invention may include a fluid dynamic pressure bearing device of a motor as described above, and further include a stator that is fixed to the base, and a rotor that is provided with a rotor hub and a rotor magnet that is engaged with the rotor hub and generates a rotation magnetic field in cooperation with the stator, and is rotatably arranged with respect to the base. The fluid dynamic pressure bearing device supports rotation of the rotor, and the rotor is drawn by a magnetic force in a direction opposite to a direction in which a thrust dynamic pressure acts. The thrust dynamic pressure generated in the thrust dynamic pressure groove generates a dynamic pressure that receives a load of the rotor in a thrust direction, and the load is supported by balancing the thrust dynamic pressure and the magnetic force. The rotor hub and the bearing member may be integrally formed. When the rotor hub and the bearing member are thus integrated, the assembly operation of the bearing member and the rotor can be omitted, and generation of assembly errors can be suppressed. As a result, accuracy of the bearing device itself is improved. Furthermore, the number of parts is reduced, whereby the cost can be reduced.

A recording disk drive device according to this invention may include the spindle motor as described, and further include a head that writes and/or reads information with respect to a recording disk that is rotatingly driven by the spindle motor. According to this recording disk drive device, even if the device is made smaller and thinner, high bearing rigidity can be obtained, and a recording disk drive device with high reliability can be provided at a lower cost.

According to exemplary embodiments of a fluid dynamic pressure bearing device according to this invention, even if the device is small and thin, the necessary axial direction length of the radial dynamic pressure bearing portion can be obtained, and necessary bearing rigidity can be obtained, without increasing the diameter of the radial dynamic pressure bearing portion, and without reducing the mounting rigidity of the shaft member. Therefore, a spindle motor using the fluid dynamic pressure bearing device or a recording disk drive device using the fluid dynamic pressure bearing device can be made smaller and thinner, and electricity consumption can be suppressed.

These and other features, objects and/or advantages are described in or apparent from the following detailed description of exemplary embodiments.

### BRIEF DESCRIPTION OF THE DRAWINGS

Exemplary embodiments are described with references to the accompanying drawings, in which like numerals represent like parts, and in which:

FIG. 1 is a cross-sectional view showing an overview of a hard disk drive device related to a first embodiment of the invention of this application;

FIG. 2 is a cross-sectional view showing details of main portions of the hard disk drive device related to the first embodiment;

FIG. 3 is a cross-sectional view showing a fluid dynamic pressure bearing device of a hard disk drive device related to a second embodiment of the invention of this application;

FIG. 4 is a cross-sectional view showing a fluid dynamic pressure bearing device of a hard disk drive device related to a third embodiment of the invention of this application; and

FIG. 5 is a cross-sectional view of main portions of a hard disk drive device related to a fourth embodiment of the invention of this application.

### DETAILED DESCRIPTION OF EMBODIMENTS

The following explains exemplary embodiments of the invention with reference to the drawings. In the following explanation, the description concerning upward and downward directions refers to the directions in the figures.

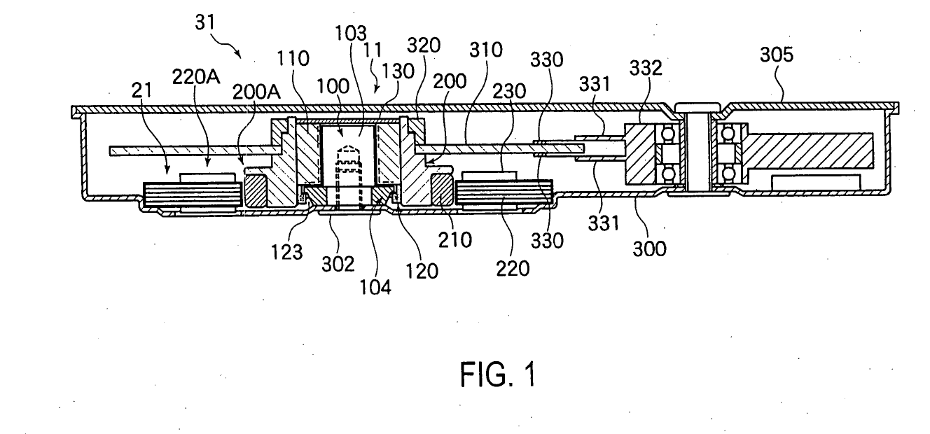

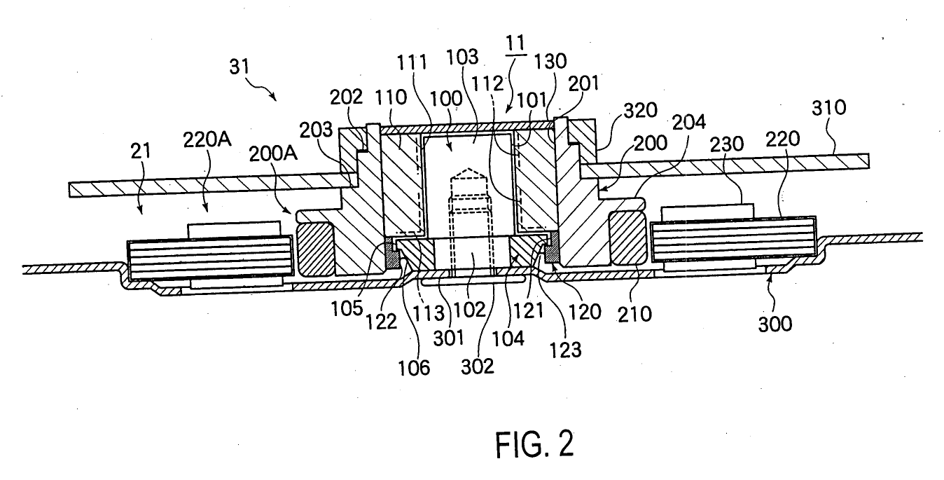

### First Embodiment: FIGS. 1 and 2

FIG. 1 shows an overall diagram of a hard disk drive device 31 that houses a spindle motor 21 as a drive source. FIG. 2 shows a detailed structure of main portions of the device 31. The spindle motor 21 is provided with a fluid dynamic pressure bearing device 11. Hereafter, exemplary structures of the fluid dynamic pressure bearing device 11, the spindle motor 21, and the hard disk drive device 31 are explained in this order.

(A) Fluid Dynamic Pressure Bearing Device 11

As shown in FIG. 2, the fluid dynamic pressure bearing device 11 may be constituted by a shaft member 100, a bearing member 110, a bearing member-side annular member 120, and a lid member 130.

The shaft member 100 has a cylindrical shape, and may have a step in which a small diameter portion 102 of the shaft is formed below a large diameter portion 101. A shaft member-side annular member 104 may be engaged with the small diameter portion 102 of the shaft member 100. The lower end surface of the shaft member-side annular member 104 may be coplanar with the lower end surface of the shaft member 100. A step may be formed on the outer periphery of the shaft member-side annular member 104. An outer circumferential surface 105 is formed above this step, and a tapered surface 106, of which a diameter is smaller than the outer circumferential surface 105, is formed below the step. The diameter of the tapered surface 106 reduces progressing downward (toward a base member 300, which will be described later). Furthermore, this tapered surface 106 can be changed to a cylindrical surface, or the step can be removed and the entire outer circumferential surface of the shaft member-side annular member 104 can be made into a tapered surface.

The bearing member 110 has a cylindrical shape slightly larger than the outer diameter of the shaft member-side annular member 104, and a hollow portion 111 of the bearing member 110 is engaged with the shaft member 100. A micro gap is formed between the inner circumferential surface of the bearing member 110, which forms the hollow portion 111, and the outer circumferential surface 103 of the shaft member 100. A micro gap is also formed between the lower end surface of the bearing member 110 and the upper end surface of the shaft member-side annular member 104. An opening in the upper portion of the bearing member 110 is sealed by the lid member 130. This lid member 130 may be engaged with an inner periphery of an upper end opening of a later-described rotor hub 200. The lower end surface of the lid member 130 may contact an upper end surface of the bearing member 110, and a micro gap is formed between the lower end surface of the lid member 130 and the upper end surface of the shaft member 100. As an alternative, it is also possible to form a concave portion at the upper end surface of the bearing member 110, and to engage the lid member 130 with the concave portion.

The bearing member-side annular member 120 is arranged in the vicinity of the shaft member-side annular member 104 and may be engaged with the inner circumferential surface of a lower end of a central hole 201 of the rotor hub 200 (the axial direction end at which there is an opening). The upper end surface of the bearing member-side annular member 120 preferably contacts the lower end surface of the bearing member 110. In the inner circumferential portion of the bearing member-side annular member 120, an annular concave portion (large-diameter inner circumferential surface) 121 is formed at the upper part, and an inner circumferential surface 122 is formed at the lower part. The outer circumferential surface 105 of the shaft member-side annular member 104 is engaged with the annular concave portion 121 via a micro gap, and the inner circumferential surface 122 is adjacent to the tapered surface 106, and is arranged facing the tapered surface 106 via a micro gap. Furthermore, if the entire outer circumference of the shaft member-side annular member 104 is a tapered surface, the entire surface of the inner circumferential portion of the bearing member-side annular member 120 can also be formed as a tapered surface. Therefore, both tapered surfaces face each other, and a later-described capillary seal portion 123 can be formed therebetween.

The above-mentioned micro gaps are continuous, and lubricant continuously fills and seals the micro gaps. A micro gap between the tapered surface 106 of the shaft member-side annular member 104 and the inner circumferential surface 122 of the bearing member-side annular member 120 is a cross-sectionally triangle-shaped gap that narrows progressing upward. This micro gap forms a capillary seal portion 123 and suppresses lubricant from leaking to the outside.

The fluid dynamic pressure bearing device 11 of this embodiment is configured in a state in which the shaft member 100 is fixed, and the bearing member 110 is rotated. On either the outer circumferential surface 103 of the shaft member 100 or the inner circumferential surface of the bearing member 110 facing the outer circumferential surface 103, a radial dynamic pressure groove is formed. Furthermore, on either the upper end surface of the shaft member-side annular member 104 or the lower end surface of the bearing member 110 facing the upper end surface, a thrust dynamic pressure groove is formed. In this embodiment, radial dynamic pressure grooves 112 are formed on the inner circumferential surface of the bearing member 110, and a thrust dynamic pressure groove 113 is formed on the lower end surface of the bearing member 110.

The pressure grooves may have any suitable known or later-developed shape. As the radial dynamic pressure grooves 112, for example, on the inner circumferential surface of the bearing member 110, a plurality of rows of straight line-shaped grooves parallel to the axial direction or extended diagonally with respect to the axial direction, or triangular grooves, or grooves in a substantially V-shaped herringbone design can be used. Meanwhile, similarly, as the thrust dynamic pressure groove 113, a plurality of dynamic pressure grooves may have a radial shape or a spiral shape on the lower end surface of the bearing member 110, a herringbone design can be used in which a plurality of substantially V-shaped dynamic pressure grooves are formed in a circumferential direction, etc.

(B) Spindle Motor 21

As shown in FIGS. 1 and 2, the spindle motor 21 may be constituted by the fluid dynamic pressure bearing device 11, a rotor 200A formed of the rotor hub 200 and a rotor magnet 210, and a stator 220A formed of stator cores 220 and coils 230.

The rotor hub 200 may be substantially cylindrical, and the bearing member 110 may be engaged with a hole (central hole) 201 of the center portion of the rotor hub 200. The shaft member 100 mounted to the shaft member-side annular member 104 is inserted into the hollow portion 111 of the bearing member 110. Furthermore, the bearing member-side annular member 120 may be engaged with the surface of the hole 201, and may contact the lower end surface of the bearing member 110. The upper end surface of the rotor hub 200 may be positioned slightly higher than the upper end surface of the bearing member 110. Therefore, the lid member 130 may be engaged with the inner periphery of the upper end of the rotor hub 200 that is exposed by being positioned slightly higher than the upper end surface of the bearing member 110, thus sealing the upper opening portion of the bearing member 110. By so doing, the fluid dynamic pressure bearing device 11 is fixed within the rotor hub 200. Furthermore, the rotor hub 200 and the fluid dynamic pressure bearing device 11 may be incorporated into the spindle motor 21 by contacting the lower end surface of the shaft member 100 and/or the lower end surface of the shaft member-side annular member 104 with the bottom surface of the later-mentioned base member 300, and fixing them to the base member 300 using, for example, a threaded fastener.

On the upper end portion of the outer circumferential portion of the rotor hub 200, two step portions 202, 203 may be formed, with successively smaller outer diameters progressing upward. Furthermore, a flange portion 204 may be formed below the axial direction center of the outer circumferential portion of the rotor hub 200. An annular rotor magnet 210 is engaged with the outer circumferential portion under the flange portion 204, and contacts the lower end surface of the flange portion 204. In the vicinity of the rotor magnet 210, stator cores 220 are arranged, which may be formed of laminated electromagnetic steel plates. The coils 230 are wound about a plurality of protruding pole portions provided by the stator cores 220, and stators 220A are thus constituted. The stator cores 220 are fixed to the base member 300.

The above explanation describes the spindle motor 21 of this embodiment. According to the motor 21, when a predetermined current is supplied to the coils 230, a magnetic flux is generated from the stator cores 220. Because of this magnetic flux, a magnetic force acts on the rotor magnet 210, and the rotor hub 200 integrated with the bearing member 110 is rotated about the shaft member 100.

The base member 300 may be formed of an iron material such as rolled steel plate or the like having magnetic properties, and draws the entire rotor in the axially downward direction by a magnetic force generated between the base member 300 and the rotor magnet 210. The magnetic force that acts so as to draw the entire rotor in the axially downward direction supports the entire rotor 200A by balancing a dynamic pressure force in the axially upward direction generated by the thrust dynamic pressure groove 113 during rotation of the rotor hub 200, and the bearing member 110 and the bearing member-side annular member 120 are rotated without contacting the shaft member 100 and the shaft member-side annular member 104. Furthermore, the spindle motor 21 of this embodiment is an inner rotor type in which the rotor magnet 210 is arranged facing the inner circumferential surfaces of the stator cores 210.

(C) Hard Disk Drive Device 31

As shown in FIGS. 1 and 2, the hard disk drive device 31 may be constituted by the spindle motor 21, the base member 300, a cover member 305 that seals against the base member 300 to form an enclosed space, a recording disk 310, a clamp member 320, and magnetic heads 330 that write and/or read information with respect to the recording disk 310.

The base member 300 has a thin box shape, and may be made of rolled steel plate or the like. As shown in FIG. 2, a bearing fixing portion 301 that slightly rises upward may be formed in the base member 300. The fluid dynamic pressure bearing device 11 is fixed to the bearing fixing portion 301. That is, the lower end surface of the shaft member 100 and/or the lower end surface of the shaft member-side annular member 104, which may be coplanar, of the fluid dynamic pressure bearing device 11 contact the upper surface of the bearing fixing portion 301, and a threaded fastener, e.g., a screw 302, that goes through the bearing fixing portion 301 may be threadedly fastened into the center of the shaft member 100. Thus, the shaft member 100 is attached to the base member 300. It is important for the shaft member 100 to be fixed in a state in which the axial direction is perpendicular to the surface of the base member 300 with high accuracy. Thus, by using the screw 302 to fix the fluid dynamic pressing bearing device 11, a press-in amount for pressing in the shaft member 100, as seen in a conventional device, is not needed. This helps the axial direction length of the radial dynamic pressure bearing portion to be sufficiently obtained.

As described above, steps 202, 203 may be formed on the upper end portion of the outer circumferential portion of the rotor hub 200. The inner circumferential portion of the recording disk 310 may be engaged with the step portion 203, which is lower than the step portion 202. Furthermore, a clamp member 320 may be engaged with the step portion 202, which is higher than the step portion 203, and the recording disk 310 may be rigidly supported on the rotor hub 200 so as to be sandwiched by the clamp member 302 and the step portion 203.

Furthermore, the above-mentioned stator cores 220 may be fixed to the base member 300 near the rotor magnet 210. The magnetic heads 330 are mounted to the tip end of a pair of upper and lower arms 331 that is rotatably supported at an appropriate location of the base member 300. The magnetic heads 330 are arranged so as to sandwich the recording disk 310 and write and/or read information with respect to both surfaces of the recording disk 310.

In the hard disk drive device 31 constituted as described above, while the spindle motor 21 is rotated, the recording disk 310 is rotated integrally with the rotor hub 200, and information is written and/or read by the magnetic heads 330 with respect to the recording disk 310. During this operation, in the fluid dynamic pressure bearing device 11, lubricant within the radial dynamic pressure grooves 112 formed in the inner circumferential surface of the bearing member 110 has a high pressure, a radial dynamic pressure that acts inward in the diameter direction is generated, and a radial load is supported with high rigidity. Furthermore, lubricant within the thrust dynamic pressure groove 113 formed in the lower end surface of the bearing member 110 has a high pressure, a thrust dynamic pressure that acts in the axially upward direction is generated, and a thrust load is supported with high rigidity. Furthermore, the rotor hub 200 is drawn by a magnetic force in a direction (axially downward direction) opposite to a direction in which a thrust dynamic pressure acts (axially upward direction), and an axial direction load of the entire rotor 200A and the recording disk 310 is supported by balancing the magnetic force and the thrust dynamic pressure.

The following explains effects of the hard disk drive device 31 of this embodiment.

The shaft member 100 of the fluid dynamic pressure bearing device 11 may be fixed to the base member 300 in a state in which the lower end surface of the shaft 100 and/or the lower end surface of the shaft member-side annular member 104, of which the diameter is larger than that of the shaft member 100, contact the base member 300. Because of this, the shaft member 100 can be stably fixed with high accuracy with respect to the base member 300. That is, the shaft member 100 can be fixed in a state in which the axial direction of the shaft member 100 is perpendicular to the bottom surface of the base member 300 with high accuracy, and the shaft mounting rigidity can be improved. Furthermore, because the fluid dynamic pressure bearing device 11 is fixed to the base member 300 by the screw 302, a press-in amount for pressing in the shaft member 100, as seen in a conventional device, is not needed. Therefore, the axial direction length of the radial dynamic pressure bearing portion is sufficiently obtained. As a result, bearing rigidity of the fluid dynamic pressure bearing device 11 is sufficiently obtained, and even if the device is thin, a spindle motor 21 having a stable, accurate rotation characteristic with high accuracy can be accomplished. If this spindle motor 21 is used, the entire hard disk drive device 31 can be made thinner and smaller. Furthermore, the diameter of the radial dynamic pressure bearing portion of the shaft member 100 does not need to be increased, and electricity consumption can be suppressed. From this point as well, the spindle motor 21 is useful in a small hard disk drive device.

Furthermore, in the fluid dynamic pressure bearing device 11, the outer circumferential surface 105 of the shaft member-side annular member 104 is engaged with the annular concave portion 121 of the bearing member-side annular member 120, and the inner circumferential surface 122 of the bearing member-side annular member 120 is adjacent to the tapered surface 106 of the shaft member-side annular member 104. According to this structure, the bearing member 110 is suppressed from being pulled out in a direction opposite to the base member 300, and in turn, the rotor hub 200 is suppressed from being pulled out. Additionally, the bearing member 110 may be suppressed from being pulled out toward the base member 300 by contacting the bearing member 110 itself with the shaft member-side annular member 104.

With respect to pull-out suppression of the bearing member 110 in a direction opposite to the base member 300, for example, a structure can be considered in which a pair of flange portions is formed on the upper and lower end portions of the shaft member, the bearing member is inserted therebetween, and one of the flange portions is engaged with a step portion arranged on the inner circumferential surface of the bearing member. Another structure can be considered in which a flange portion is formed on the upper end portion of the shaft member, and the lower end portion is pressed into the base member, etc. However, the former requires an axial direction length for forming a second flange portion, and the latter requires an axial direction length for the press-in amount. In either case, the axial direction length available for the radial dynamic pressure bearing portion is reduced.

Meanwhile, in this embodiment, pull-out suppression is performed by engaging the annular concave portion 121 of the bearing member-side annular member 120 with the outer circumferential surface 105 of the shaft member-side annular member 104 that forms a thrust dynamic pressure bearing portion. Additionally, a structure is used in which the shaft member-side annular member 104 is engaged with the lower end portion of the shaft member 100, and the lower end portion of the shaft member-side annular member 104 and/or the lower end portion of shaft member 100, which may be coplanar, contact the base member 300 and are fixed by the screw 302. Therefore, the axial direction length for forming a second flange portion and the axial direction length for a press-in amount are not required. Because of this, the axial direction length of the radial dynamic pressure bearing portion of the shaft member 100 (in this case, substantially corresponding to the axial direction length of the outer circumferential surface of the large diameter portion 101) is not reduced. In other words, the radial dynamic pressure bearing portion of the shaft member 100 can be maximized. From this point as well, this embodiment is preferable for a thin hard disk drive device, and even if the device is thin, bearing rigidity can be obtained.

In the foregoing description, material characteristics of each member of the fluid dynamic pressure bearing device 11 are not described. However, for each member, conventionally, a well-known steel or sintered alloy or the like, which may include a special steel such as a carbon steel, a stainless steel, etc., may be appropriately used. Here, by forming the shaft member-side annular member 104, which contacts the base member 300, of tempered steel, a shaft member-side annular member 104 with high rigidity can be obtained. By so doing, stability of the shaft member 100 fixed to the base member 300, that is, mounting rigidity of the shaft member 100, can be increased. A martensitic stainless steel or a high carbon chrome bearing steel can be listed as an example of a steel to be used. Furthermore, in this state, if the surface of the shaft member-side annular member 104 that contacts the base member 300 is polished after heat processing, mounting accuracy of the shaft member 100 with respect to the base member 300 can be further improved. Additionally, if the upper end surface of the shaft member-side annular member 104 (a thrust dynamic pressure generating surface facing the lower end surface of the bearing member 110) is polished after heat processing, rotation accuracy can be improved by generating a thrust dynamic pressure without any deviation with respect to the rotation axis.

The following explains second through fourth embodiments of the invention of this application. In the figures of these embodiments, the same symbols are used for the members having the same functions as in embodiment 1, and the explanation is omitted. Additionally, the second and third embodiments show other embodiments of a fluid dynamic pressure bearing device, and the fourth embodiment shows another embodiment of a spindle motor to which the fluid dynamic pressure bearing device 11 of the first embodiment may be applied.

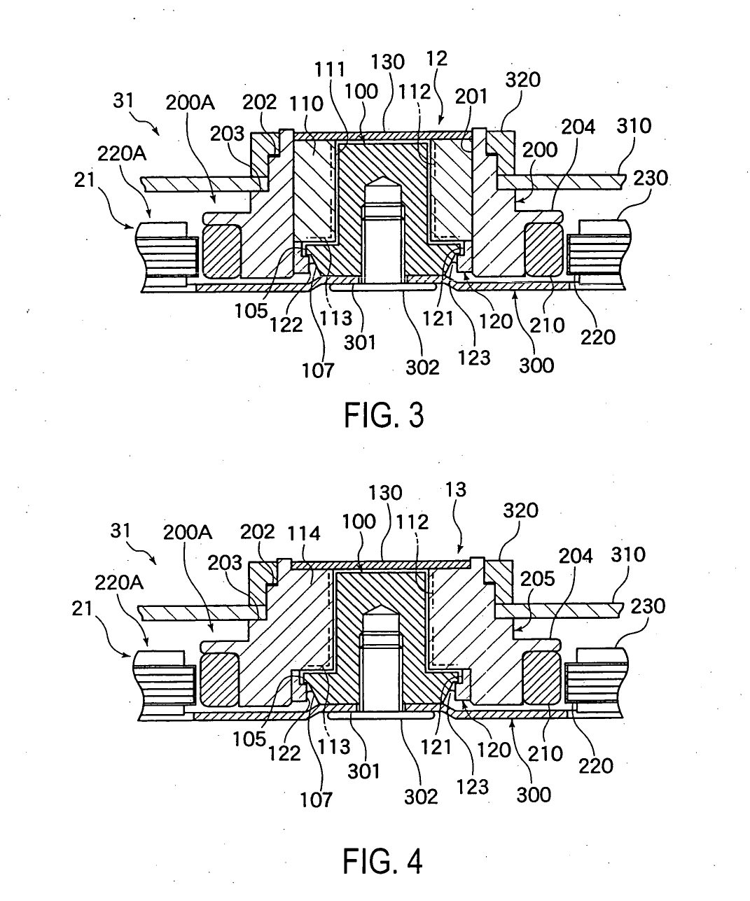

### Second Embodiment: FIG. 3

The shaft member 100 of a fluid dynamic pressure bearing device 12 provided in the hard disk drive device 31 shown in FIG. 3 is the shaft member 100 of the first embodiment, but having the shaft member-side annular member 104 formed integrally therewith. That is, a flange portion 107 is arranged on the lower end portion of the shaft member 100, and this flange portion 107 is used to form the shaft member-side annular member integrally with the lower end portion of the shaft member 100.

Thus, according to the embodiment in which the flange portion 107 is formed integrally with the shaft member 100, the assembly operation of the first embodiment in which the shaft member-side annular member 104 is engaged with the shaft member 100 can be omitted, and generation of assembly errors can be suppressed. As a result, accuracy of the bearing device itself is improved. Furthermore, the number of parts is reduced, whereby the cost can be reduced.

### Third Embodiment: FIG. 4

In a fluid dynamic pressure bearing device 13 provided in the hard disk drive device 31 shown in FIG. 4, the bearing member 110 and the rotor hub 200 that are shown in the first embodiment are integrated (integrally formed). Here, the integrated item is called a rotor hub 205. Thus, in the rotor hub 205, in the inner circumferential portion, a cylindrical bearing portion 114 that protrudes inward in the diameter direction is integrally molded. Furthermore, as shown, the shaft member 100 of the second embodiment may be used as the shaft member.

According to this embodiment, the bearing portion 114 is formed integrally with the rotor hub 205. Thus, the assembly operation of the first embodiment in which the rotor hub 200 is engaged with the bearing member 110 can be omitted, and generation of assembly errors can be suppressed. As a result, accuracy of the bearing device itself is improved. Furthermore, the number of parts is reduced, whereby the cost can be reduced.

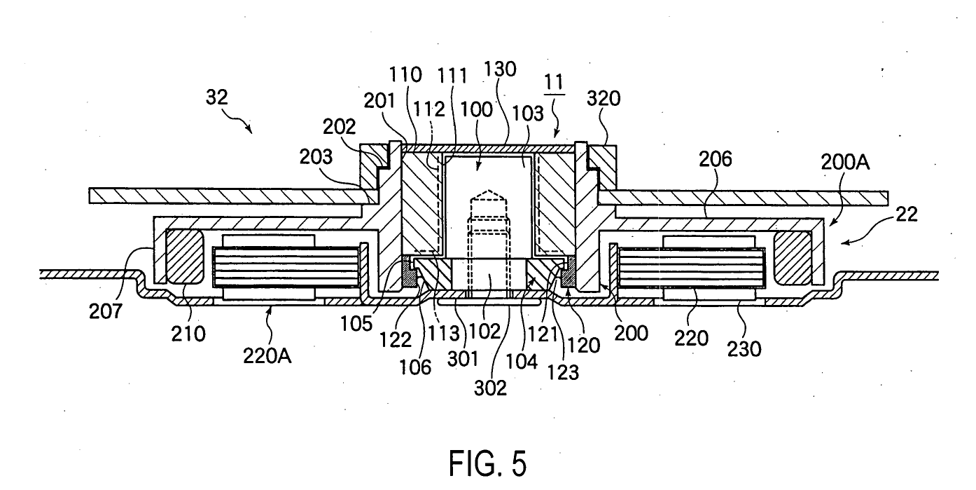

### Fourth Embodiment: FIG. 5

Instead of the spindle motor 21 of the first embodiment, FIG. 5 shows details of the portion of a spindle motor 22 of a hard disk drive device 32 provided with the spindle motor 22 of another embodiment. In this spindle motor 22, instead of the flange portion 204 formed on the rotor hub 200, a disk portion 206, of which an outer periphery extends circumferentially outward beyond the outer circumferential portion of the stator cores 220, is formed integrally with the rotor hub 200. At the outer circumferential portion of the disk portion 206, an annular portion 207 is integrally formed that projects downward toward the base member 300. A rotor magnet 210 is engaged with the inner circumferential surface of the annular portion 207, and the inner circumferential surface of the rotor magnet 210 faces the outer circumferential surface of the stator cores 220.

The rotor magnet 210 is preferably arranged at a position slightly higher than the stator cores 220. By so doing, the entire rotor 200A is drawn in the axially downward direction by a magnetic force generated between the rotor magnet 210 and the stator cores 220. The magnetic force that acts to draw the entire rotor in the axially downward direction supports the entire rotor 200A by balancing a dynamic pressure force in the axially upward direction generated by the thrust dynamic pressure groove 113 during the rotation of the rotor hub 200, and the bearing member 110 and the bearing member-side annular member 120 are rotated without contacting the shaft member 100 and the shaft member-side annular member 104.

The spindle motor 22 of this embodiment is an outer rotor type in which the rotor magnet 210 is arranged on the outer circumferential side of the stator stores 220, and is a type different from the inner rotor type spindle motor 21 of the first embodiment, but is provided with the same fluid dynamic pressure bearing device 11, so the same effects can be given.

The above-mentioned respective embodiments show examples in which embodiments of the invention are applied to a hard disk drive device, but the invention of this application also can be applied to a recording disk drive device that drives a portable media recording disk such as a CD or DVD. With respect to the recording disk drive device for this case, a disk mounting mechanism that can detachably mount the recording disk may be arranged in the rotor hubs 200, 205 instead of the clamp member 320. Furthermore, the magnetic heads 330 can be replaced with optical heads.

While the invention has been described in connection with specific exemplary embodiments, these embodiments should be viewed as illustrative and not limiting. Various changes, substitutes and improvements are possible within the spirit and scope of the invention.

What is claimed is:

1. A fluid dynamic pressure bearing device, comprising:
a shaft member including a first end that attaches to a base member of a motor;
a bearing member that engages a rotor hub of the motor, a micro gap being formed between the shaft member and the bearing member;
a shaft member-side annular member engaged with the shaft member, the shaft member-side annular member including a first end surface that contacts the base member of the motor, an outer circumferential surface of the shaft member-side annular member including a step and/or a taper that reduces in diameter progressing toward the first end surface;
a bearing member-side annular member that engages with the bearing member and/or with the rotor hub of the motor, an inner circumferential surface of the bearing member-side annular member including a step and/or a taper that reduces in diameter progressing toward the base member of the motor;
the outer circumferential surface of the shaft member-side annular member and the inner circumferential surface of the bearing member-side annular member facing each other and being adjacent to each other in an axial direction and in a radial direction;
a capillary seal portion that suppresses lubricant occupying the micro gap from leaking being formed between the shaft member-side annular member and the bearing member-side annular member;
at least one first dynamic pressure groove formed in either an outer circumferential surface of the shaft member or an inner circumferential surface of the bearing member, the at least one first dynamic pressure groove generating a radial dynamic pressure receiving a load in a radial direction; and
at least one second dynamic pressure groove formed in either a second end surface of the shaft member-side annular member facing the bearing member or an end surface of the bearing member facing the second end surface of the shaft member-side annular member, the at least one second dynamic pressure groove generating a thrust dynamic pressure receiving a load in a thrust direction.

2. The fluid dynamic pressure bearing device as set forth in claim 1, wherein the shaft member-side annular member is formed of tempered steel.

3. The fluid dynamic pressure bearing device as set forth in claim 2, wherein the first end surface of the shaft member-side annular member, which contacts the base member, is polished after heat processing.

4. The fluid dynamic pressure bearing device as set forth in claim 2, wherein the second end surface of the shaft member-side annular member, which faces an end surface of the bearing member, is polished after heat processing.

5. The fluid dynamic pressure bearing device as set forth in claim 1, wherein an end portion of the bearing member opposite to the base member has an opening, and this opening is sealed by a lid member.

6. The fluid dynamic pressure bearing device as set forth in claim 1, wherein the shaft member-side annular member and the shaft member are integrally formed.

7. The fluid dynamic pressure bearing device as set forth in claim 1, wherein a threaded opening is formed in the first end of the shaft member to receive a threaded fastener that passes through the base member.

8. A spindle motor, comprising:
the fluid dynamic pressure bearing device as set forth in claim 1,
a base member;
a stator that is fixed to the base member; and
a rotor including a rotor hub and a rotor magnet that is engaged with the rotor hub and generates a rotation magnetic field in cooperation with the stator, the rotor being rotatably arranged with respect to the base, wherein:
the fluid dynamic pressure bearing device supports rotation of the rotor; and
the rotor is drawn by a magnetic force in a direction opposite to a direction in which the thrust dynamic pressure acts, and the load of the rotor in the thrust direction is supported by balancing the thrust dynamic pressure and the magnetic force.

9. The spindle motor as set forth in claim 8, wherein the rotor hub and the bearing member are integrally formed.

10. A recording disk drive device; comprising:
the spindle motor as set forth in claim 8; and
a head that writes and/or reads information with respect to a recording disk,
wherein the spindle motor rotatingly drives the recording disk.
